(19) United States
(12) Patent Application Publication
(10) Pub. No.: US 2007/0052850 A1
(43) Pub. Date: Mar. 8, 2007

(54) Low overhead audio/video intercom system

(76) Inventors: David Vinson, Cupertino, CA (US); Yancy Chen, Campbell, CA (US); David Skinner, Redwood Shores, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/209,263

(22) Filed: Aug. 23, 2005

(51) Int. Cl. H04N 7/00

(52) U.S. Cl. 348/552

(57) ABSTRACT

An audio/video intercom system provides transmission of video and audio signals from a remote originating unit to a computer monitor and speaker for display and reproduction. The system includes an access point router coupled to the computer that receives the remotely originated video and audio signals. The access point router provides the remotely originated video and audio signals to the computer to enable display of the video signals on the monitor and reproduction of the audio signals on the computer speaker.

### BACKGROUND OF THE INVENTION

Intercom systems are well known in the art after having been employed in homes and businesses for years. Such traditional intercom systems employ microphone/speaker units distributed throughout the various rooms of a building. The units are interconnected by cable or networks dedicated to that purpose so that audio communication may be exchanged between rooms or to enable music to be piped throughout the building. Such traditional intercoms may provide video communication for security purposes. However, these require dedicated distribution means and reproduction equipment. They also do not provide ready logging of video or audio for security purposes.

Wireless cameras are known for surveillance purposes but do not offer communication functionality. Also, non-wireless surveillance cameras require dedicated networks for distributing their video signals.

From the foregoing, intercom systems are not generally suitable for security purposes. Dedicated distribution cabling or networking is required. Hence, there is a need for a more integrated intercom system which exhibits low overhead by utilizing existing network infrastructure and which offers integrated intercom and security camera functionality along with ready security logging. The present invention provides such a system and remote camera-microphone units for use in such systems.

### SUMMARY OF THE INVENTION

In one embodiment of the invention, an audio/video intercom system comprises a computer, a monitor that displays images from video signals generated by the computer, and a speaker that reproduces sound from audio signals generated by the computer. The system further comprises a remote camera and microphone unit that generate remotely originated video and audio signals. The remote unit includes a transmitter that transmits the remotely originated video and audio signals. The system further includes an access point router coupled to the computer that receives the remotely originated video and audio signals and provides the remotely originated video and audio signals to the computer for generation of corresponding video and audio signals to be displayed by the monitor and reproduced by the speaker.

In another embodiment of the invention, a device comprises a camera that generates a video signal from an image, a microphone that generates an audio signal from sensed sound, a housing enclosing the camera and microphone, and a transmitter within the housing that transmits the video and audio signals for reception by an access point router and distribution to a computer and monitor.

### BRIEF DESCRIPTION OF THE DRAWING

FIG. 1 is a simplified schematic representation of a wireless intercom/surveillance system according to one embodiment of the invention;

FIG. 2 is a simplified schematic representation of a wireless intercom/surveillance system within a residence according to another embodiment of the invention;

FIG. 3 is a simplified schematic representation of an intercom/surveillance system utilizing existing AC power lines for communication and distribution according to a further embodiment of the invention;

FIG. 4 is a perspective view of a remote audio/video unit according to an embodiment of the invention;

FIG. 5 is a perspective view of another remote audio/video unit according an embodiment of the invention;

FIG. 6 is a top plan view of the unit of FIG. 5; and

FIG. 7 is a perspective view of a further remote audio/video unit according to an embodiment of the invention.

### DESCRIPTION OF THE INVENTION

In the following detailed description of exemplary embodiments of the invention, reference is made to the accompanying drawings, which form a part hereof. The detailed description and drawings illustrate exemplary embodiments by which the invention may be practiced. These embodiments are described in sufficient detail to enable those skilled in the art to practice the invention. It is understood that other embodiments may be utilized, and other changes may be made, without departing from the spirit or scope of the present invention. The following detailed description is therefore not to be taken in a limiting sense, and the scope of the present invention is defined by the appended claims.

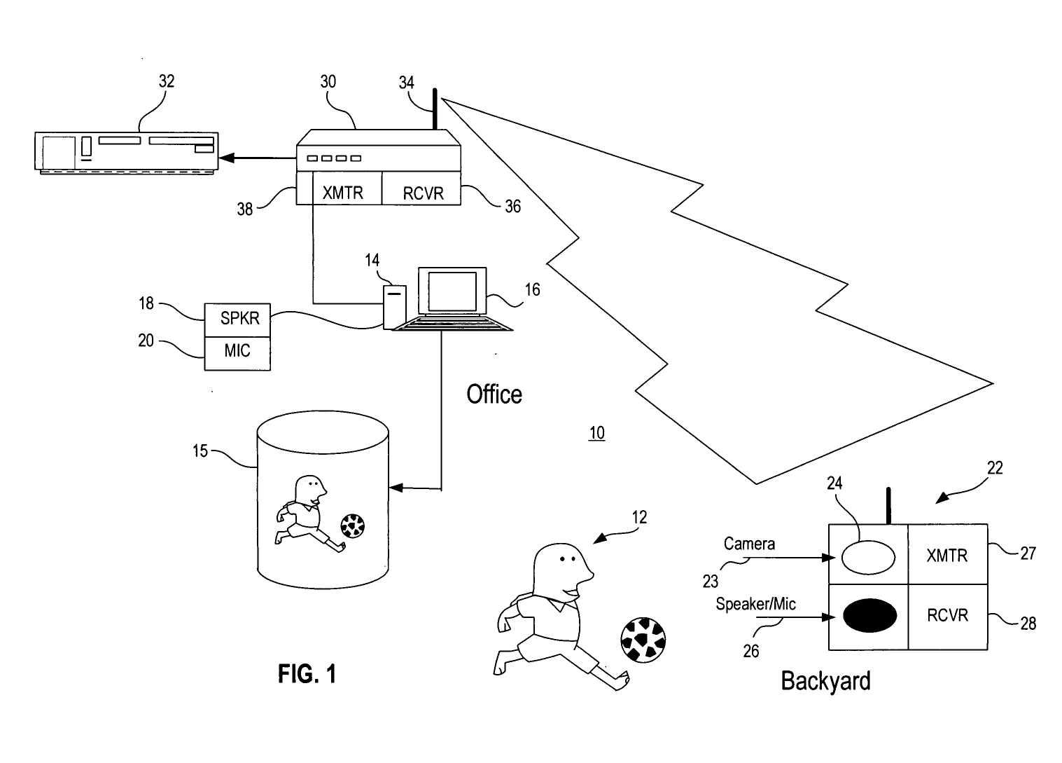

Referring now to FIG. 1, it shows an audio/video intercom/surveillance system 10 being utilized for watching and recording a child 12 at play within a backyard. The system 10 is arranged according to one embodiment of the present invention. The system generally includes a computer 14, a monitor 16, and a speaker 18. Associated with the speaker 18 is a microphone 20. The system further comprises a remote camera and microphone unit 22 and an access point router 30. The access point router 30 is coupled to the computer 14 and to a cable modem 32.

As known in the art, an “access point” is a wireless device used to connect computer and/or other wireless devices. As also known in the art, a “router” is a network device that allows devices, such as IEEE 802 devices, to be connected to the same network. Hence, the term “access point router” is used herein, as is known in the art, to refer to a combined access point (wireless device) and router.

The remote, camera, and microphone unit includes a camera 23 having a lens 24, a speaker/microphone 26, a transmitter 27, and a receiver 28. The unit 22 is remote from the computer 14 which may be, for example, in a home office. The camera 23 generates a remotely originated video signal which, as seen in FIG. 1, is the play of a child 12. The speaker/microphone 26 generates a remotely originated audio signal corresponding to the video signal. The transmitter 27 is arranged to transmit the remotely originated video and audio signals.

The access point router 30 may be of the type well known in the art. It includes an antenna 34 and a receiver 36 for receiving the transmitted video and audio signals from the remote unit 22. The remotely generated video and audio signals received by the access point router 30 are conveyed to the computer 14 enabling display of the video signals on the monitor 16 and the audio signals to be reproduced as sound by the speaker 18. In this manner, the outside play of the child 12 may be observed from a location inside of a home office, for example. The computer 14 includes a hard drive 15. The hard drive 15 provides a ready medium with which the observed play of the child 12 may be logged.

The access point router 30 is also coupled to the cable modem 32. This enables the video and audio remotely generated by the remote unit 22 and received by the access point router 30 to be seen and heard over the internet from a distant location external to the home in which the office resides.

The access point router 30 further includes a transmitter 38. This permits sound generated by the computer 14 to be transmitted from the access point router to the receiver 28 of the remote unit 22. The source of the sound may be the microphone wherein a parent may provide instruction to the child 12 remotely from the office by speaking into the microphone 20. The parent's voice is converted to an audio signal by the computer 14 which is then transmitted by the transmitter 38. Upon receipt by the receiver 28, the speaker/microphone 26 reproduces the parent's voice for communicating with the child 12.

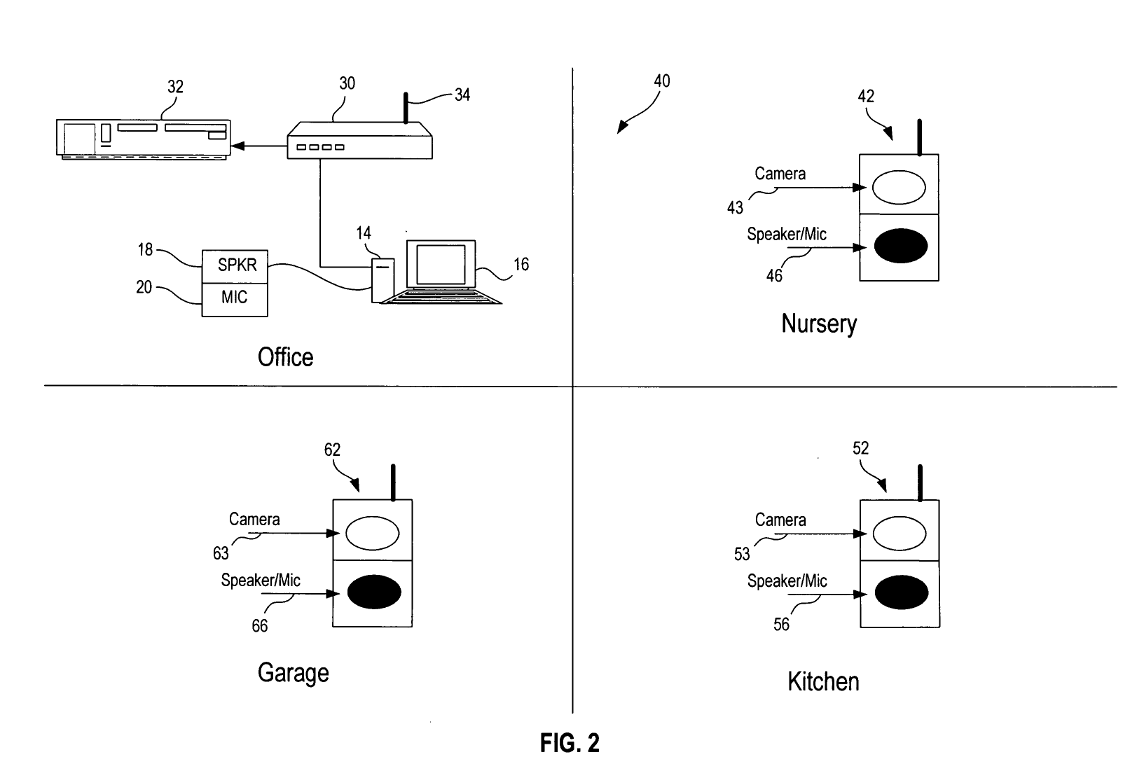

Referring now to FIG. 2, it illustrates another wireless intercom/surveillance system within a residence according to another embodiment of the invention. As will be noted in FIG. 2, the system 40 includes the computer 14, the monitor 16, and the access point router 30. Also, the system includes the cable modem 32, speaker 18, and microphone 20 which are all configured and function as previously described with respect to FIG. 1.

As may be further noted in FIG. 2, the system 40 includes a remote camera and microphone unit within each of the nursery, garage, and kitchen. The nursery includes the remote camera and microphone unit 42. The kitchen includes the remote camera and microphone unit 52. The garage includes the remote camera and microphone unit 62. The remote camera and microphone units 42, 52, and 62, each include a camera 43, 53, and 63, respectively. The remote camera and microphone units 42, 52, and 62, also include a speaker/microphone 46, 56, and 66, respectively. The remote camera and microphone units 42, 52, and 62 are arranged to function in a manner identical to the remote camera and microphone unit 22 of FIG. 1. As a result, associated transmitters and receivers have not been illustrated in FIG. 2 but it should be understood that each of the remote camera and microphones 42, 52, and 62 are contemplated as having transmitting and receiving functionality like the remote camera and microphone unit 22 of FIG. 1.

As in the embodiment of FIG. 1, the video and audio signals remotely generated by the remote units 42, 52, and 62 may be transmitted using radio frequency waves to the access point router 30. Accordingly, the action within each of the nursery, kitchen, and garage may be viewed on the monitor 16 and the audio generated as a result of activity within those areas may be selectively heard on the speaker 18. The microphone 20 may be utilized as in the previous embodiment for communicating with persons within the nursery, kitchen, or garage through the transmission of their voice signals from the access point router 30 to the receivers of the remote units 42, 52, and 62. The audio signals received by the remote units may then be reproduced as sound by their speaker microphones 46, 56, and 62.

The system of FIG. 2 may thus operate as a true intercom system. It may also be used to pipe music or other audio content throughout the nursery, kitchen, and garage areas by the transmission of such music stored in the computer 14 and transmitted by the access point router 30. Although not illustrated in FIG. 2, the computer 14 may include a hard drive for logging the video and audio signals generated by the remote units 42, 52, and 62 as illustrated, for example, in FIG. 7.

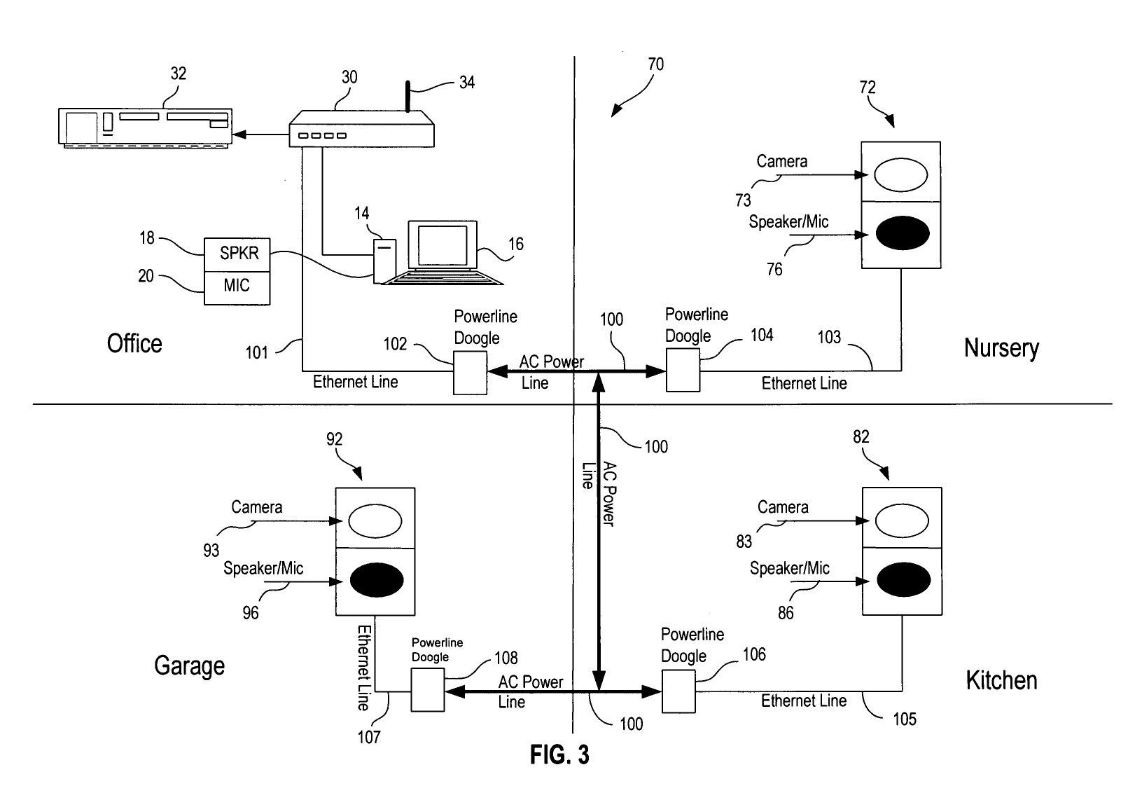

Referring now to FIG. 3, it illustrates an intercom/surveillance system 70 according to a further embodiment of the invention. Again, the system 70 includes a computer 14, a monitor 16, and an access point router 30. The computer 14 is coupled to a speaker 18 and a microphone 20. The access point router 30 is coupled to a cable modem 32. The computer 14, monitor 16, speaker 18, microphone 20, and access point router 30 all function as previously described with respect to the embodiment of FIG. 1.

The system 70 further includes remote camera and microphone units 72, 82, and 92. Each of the remote camera and microphone units 72, 82, and 92, includes a camera 73, 83, and 93, respectively, and a speaker/microphone 76, 86, and 96, respectively. The remote units 72, 82, and 92, function as previously described with respect to the embodiments of FIGS. 1 and 2.

As will be noted in FIG. 3, the video and audio signals between the remote units 72, 82, and 92 and the access point router 30 are conducted over the AC power lines 100 of the residence in which the system 70 of FIG. 3 resides. To that end, the access point router 30 is coupled to the AC power line 100 by an Ethernet line 101 and a power line doogle 102. The transmitter and receiver of remote unit 72 are coupled to the AC power line 100 by an Ethernet line 103 and a power line doogle 104. The transmitter and receiver of the remote unit 82 are coupled to the AC power line by an Ethernet line 105 and a power line doogle 106. Lastly, the transmitter and receiver of remote unit 92 are coupled to the AC power line 100 by an Ethernet line 107 and a power line doogle 108. The Ethernet protocol and the use thereof are well known in the art. Power line doogles are also well known in the art for coupling, for example, Ethernet lines to AC power lines as shown in FIG. 3.

The system of FIG. 3 incorporates the same functionality as the system of FIG. 2 except that the video and audio signals are carried over the existing AC power lines of the residence in which the system 70 resides. Again, the remote units 72, 82, and 92 may be identical to the remote unit 22 of FIG. 1 except that they are adapted for transmitted and receiving video and audio signals over Ethernet lines and thus AC power lines instead of over an RF energy communication channel.

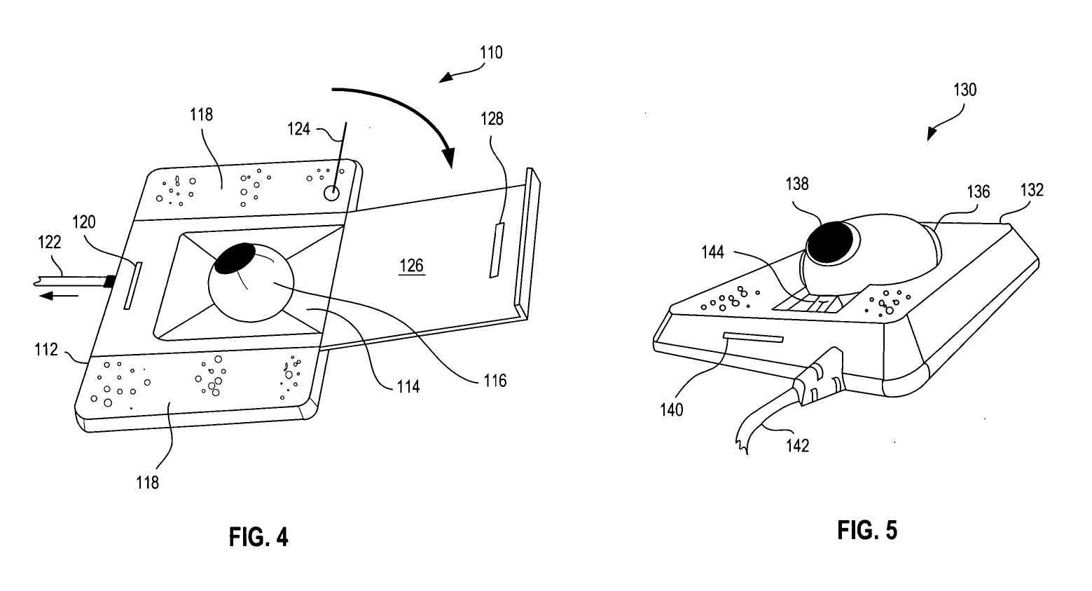

Referring now to FIG. 4, it illustrates a device 110 which comprises a remote, camera, and microphone unit according to an embodiment of the present invention and which may be utilized in any one of the systems of FIGS. 1-3. The device 110 includes a housing 112. Within the housing is a camera 114 having a lens 116, a pair of stereo speakers 118, and a microphone 120. The device 110 further includes a power cord 122 for connection to an AC power line.

The housing 112 also contains an RF transmitter and an RF receiver (not shown) which may transmit video and audio signals and receive video and audio signals with an antenna 124. As a result, the device 110 may be utilized for transmitting remotely generated video signals and remotely generated audio signals to an access router, such as access router 30 of the systems of FIGS. 1-3. The housing 112 may further include a transparent cover 126 which may cover the camera lens 116 and still permit the camera lens 116 to function for generating video signals. The cover 126 also has a slot 128 which overlies the microphone 120 when the transparent cover 126 covers the lens 116.

The device 110 may be battery powered or powered by AC power over power cord 122. Hence, the video and audio signals generated by the device 10 and received from the access point router 30 may be received over the power lines connected to the power cord 122.

The device 110 is further arranged to be placed on a desktop, for example. The device may be operative from the desktop with the transparent cover 126 being either open as illustrated or closed.

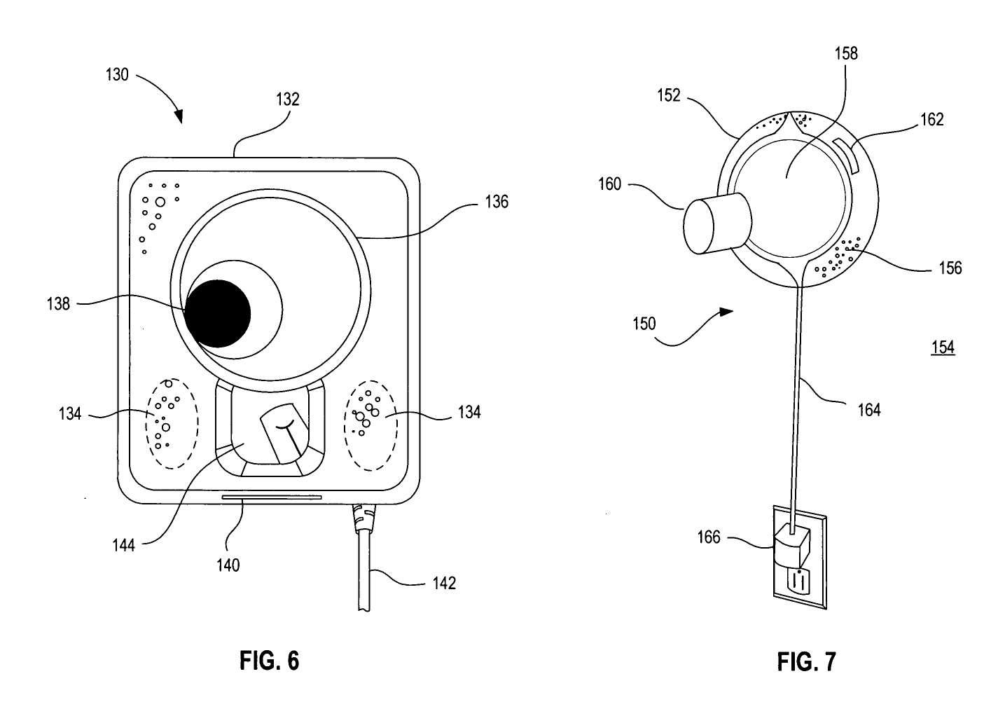

FIGS. 5 and 6 illustrate another remote audio/video unit according to another embodiment of the invention. As in the previous embodiment, the remote unit 130 includes a housing 132. The housing encloses a pair of stereo speakers 134, a camera 136 having lens 138, and a microphone 140.

The device 130 is arranged to be coupled to the AC power line by a power cord 142. Thus, the receiver and transmitter (not shown) contained within the housing 132 may be adapted for transmitting and receiving video and audio signals over the power line through an Ethernet line and a power line doogle coupled to the power cord 142 as previously described with respect to the system of FIG. 3. The device 130 may be placed on a desktop, for example, or wall mounted.

Lastly, as will be noted in FIG. 6, the device 130 further includes a video display 144. The video display 144 may be a liquid crystal display, or other type of display, for displaying the image reproduced by the lens 138. The display 144 therefore provides a convenient means by which the lens 138 may be aimed for verifying its position and intended area of coverage.

FIG. 7 illustrates another wall mountable remote audio/video unit 150 according to another embodiment of the invention. Here it may be noted that the device 150 includes a housing 152 which is mounted on a wall 154. The device 150 includes a pair of stereo speakers 156 and a camera 158. The camera 158 includes a lens 160. Also, the device 150 includes a microphone 162. Thus, the device 150 is capable of generating video and audio signals for transmission to an access point router as previously described. The device 150 is coupled to the AC power lines by its AC cord 164 and plug 166. Hence, the transmitter and receiver (not shown) may be coupled to the cord 164 over an Ethernet line and a power line doogle (not shown).

Hence, any one of the remote units 110, 130, and 150 is capable of generating remotely originated video and audio signals for transmission to an access point router. This enables the video and audio signals to be displayed on a monitor and reproduced by a speaker associated with a computer coupled to the access point router at a distant location. Hence, the invention provides an intercom/surveillance audio/video system which does not require dedicated cabling or networking. No new wires are required. Existing network infrastructure may be utilized to provide an integrated intercom/security system. Further, the system may include a hard drive associated with the computer for providing a convenient medium for logging the video and audio signals. Still further, the system may be utilized in a traditional manner to pipe music throughout any room of a residence or business in which the system is employed.

Although the present invention has been described in considerable detail with reference to certain preferred embodiments, other embodiments are possible. Therefore, the spirit or scope of the appended claims should not be limited to the description of the embodiments contained therein. It is intended that the invention reside in the claims.

We claim:

1. An audio video intercom system comprising:
a computer;
a monitor that displays images from video signals generated by the computer;
a speaker that reproduces sound from audio signals generated by the computer;
a remote camera and microphone unit that generate remotely originated video and audio signals, and
an access point router coupled to the computer that receives the remotely originated video and audio signals and provides the remotely originated video and audio signals to the computer for generation of corresponding video and audio signals to be displayed by the monitor and reproduced by the speaker.

2. The system of claim 1 further comprising a cable modem coupled to the access point router.

3. The system of claim 1 wherein the computer includes a hard drive for logging the video signals.

4. The system of claim 1 wherein the access point router is adapted to transmit audio signals to the remote camera and microphone unit for reproduction of corresponding sound by the microphone.

5. The system of claim 1 wherein the remote camera and microphone unit transmitter is a radio frequency transmitter and wherein the access point router includes a radio frequency receiver.

6. A wireless audio video intercom system comprising:
a computer;
a monitor that displays images from video signals generated by the computer;
a speaker that reproduces sound from audio signals generated by the computer;
a remote camera and microphone unit that generate remotely originated video and audio signals, and including a radio frequency transmitter that transmits the remotely originated video and audio signals; and
an access point router coupled to the computer including a radio frequency receiver that receives the remotely originated video and audio signals and provides the remotely originated video and audio signals to the computer for generation of corresponding video and audio signals to be displayed by the monitor and reproduced by the speaker.

7. A device comprising:
a camera that generates a video signal from an image;
a microphone that generates an audio signal from sensed sound;
a housing enclosing the camera and microphone; and
a transmitter within the housing that transmit the video and audio signals for reception by an access point router and distribution to a computer and monitor.

8. The device of claim 7 wherein the transmitter is a radio frequency transmitter.

9. The device of claim 7 wherein the transmitter is configured to transmit the video and audio signals over an alternating current power line.

10. The device of claim 7 wherein the transmitter is configured to transmit the video and audio signals over an Ethernet line.

11. A method comprising:
producing a video signal;
producing an audio signal;
transmitting the audio and video signals to an access point router; and
displaying the video signal on a computer monitor associated with the access point router.

12. The method of claim 11 comprising the further step of reproducing sound from the audio signal with a speaker associated with the computer.

13. The method of claim 11 comprising the further step of logging the video signal on a hard drive associated with the computer.

14. The method of claim 11 wherein the transmitting step includes transmitting with radio frequency energy.

15. The method of claim 19 comprising the further step of conveying the video and audio signals from the access point router to a cable modem.

16. An audio video intercom system comprising:
computer means for generating video signals containing images and audio signals containing sound;
display means for displaying the images from the video signals generated by the computer means;
speaker means for reproducing the sound from the audio signals generated by the computer;
remote unit means for generating remotely originated video and audio signals, and
access point router means for receiving the remotely originated video and audio signals and providing the remotely originated video and audio signals to the computer means for generation of corresponding video and audio signals for display by the display means and reproduction by the speaker means.

17. The system of claim 16 wherein the computer means includes hard drive means for logging the video signals.

18. The system of claim 16 wherein the access point router means includes means for transmitting audio signals to the remote unit means for reproduction of corresponding.

19. The system of claim 16 wherein the remote unit means includes radio frequency transmitting means for transmitting radio frequency signals and wherein the access point router means includes radio frequency receiving means for receiving the transmitted radio frequency signals.

20. The system of claim 16 wherein the remote unit means includes means for transmitting the remotely originated video and audio signals over an alternating current power line.
